(19) United States
(12) Patent Application Publication
(10) Pub. No.: US 2016/0305573 A1
(43) Pub. Date: Oct. 20, 2016

(54) HAND CONTROLLED NORMALLY CLOSED VALVE

(71) Applicant: 101247262 Saskatchewan Ltd., Maidstone (CA)

(72) Inventor: Ronald M. Kowerchuk, Maidstone (CA)

(21) Appl. No.: 15/098,226

(22) Filed: Apr. 13, 2016

(30) Foreign Application Priority Data
Apr. 15, 2015 (CA) 2887806

(51) Int. Cl. F16K 31/60; F16K 1/14; F16K 21/04

(52) U.S. Cl. CPC F16K 31/60; F16K 21/04; F16K 1/14

(57) ABSTRACT

There is provided a hand controlled valve for sampling fluid from a source of fluid, the valve having a valve body having an upper end connected to and in fluid communication with the source of fluid, the valve body having a valve seat below the upper end and a sealing member positioned within the valve body to selectively engage the seat and a fluid conduit mounted by an adjustable connection below the valve body, the adjustable connection permitting movement of the fluid conduit between a lower position and a raised position, the fluid conduit carrying an internal actuator, the internal actuator displacing the sealing member from the seat when the fluid conduit is moved from the lower position to the raised position.

### TECHNICAL FIELD

This relates to a hand controlled, normally closed valve for use with a source of fluid.

### BACKGROUND

When sampling fluids, a valve is often provided to control the flow of fluid through the test line. To prevent human error that may result in fluid leaks, it is a good idea to include a valve that is normally closed when not expressly opened by the user. This type of valve may also be used in other circumstances as well. One example of such a valve is found in U.S. Pat. No. 7,093,615.

### SUMMARY

According to an aspect, there is provided a normally closed valve that is hand-controlled and designed to be used for sampling fluid from a source of fluid. The valve comprises a valve body having an upper end connected to and in fluid communication with the source of fluid, the valve body having a valve seat below the upper end and a sealing member positioned within the valve body to selectively engage the seat and a fluid conduit mounted by an adjustable connection below the valve body. The adjustable connection permits movement of the fluid conduit between a lower position and a raised position, the fluid conduit carrying an internal actuator, the internal actuator displacing the sealing member from the seat when the fluid conduit is moved from the lower position to the raised position.

According to another aspect, the source of fluid may be a fluid pipe.

According to another aspect, the sealing member may be a ball.

According to another aspect, the adjustable connection may be a flexible sleeve that contracts as the fluid conduit moves to the raised position.

According to another aspect, the adjustable connection may be a corrugated rubber sleeve.

According to another aspect, the sealing member may be fixedly attached to the internal actuator.

According to another aspect, the weight of the fluid conduit may bias the sealing member to a sealed position.

According to an aspect, there is provided a method of using a hand controlled, normally closed valve with a source of fluid, the method comprising providing a valve comprising a valve body having an upper end connected to and in fluid communication with the source of fluid, the valve body having a valve seat below the upper end and a sealing member positioned within the valve body to selectively engage the seat, and a fluid conduit mounted by an adjustable connection below the valve body, the adjustable connection permitting movement of the fluid conduit, the fluid conduit carrying an internal actuator, causing fluid to flow out of the fluid conduit by applying an upward force to the fluid conduit to move the fluid conduit from a lower position to a raised position, the internal actuator displacing the sealing member from the seat as the fluid conduit moves upwards, and stopping fluid flow out of the fluid conduit by releasing the fluid conduit and allowing gravity to return the fluid conduit to a lower position, the internal actuator disengaging from the sealing member and the sealing member engaging the seat to establish a seal.

According to another aspect, the source of fluid may be a fluid pipe.

According to another aspect, the sealing member may be a ball.

According to another aspect, the adjustable connection may be a flexible sleeve that contracts as the fluid conduit moves to the raised position.

According to another aspect, the adjustable connection may be a corrugated rubber sleeve.

According to another aspect, the sealing member may be fixedly attached to the internal actuator.

According to another aspect, the weight of the fluid conduit may bias the sealing member to a sealed position.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a hand controlled valve;

FIG. 2 is a side elevation view of the valve shown in FIG. 1;

FIG. 3 is a side elevation view of a section of the valve through the line E-E in FIG. 2, where the sealing member is shown in a sealed position;

FIG. 4 is a side elevation view of the section of the valve shown in FIG. 1, where the sealing member is shown in an open position;

FIG. 5 is a side elevation view of a sealing member and internal actuator for the valve shown in FIG. 1;

FIG. 6 is a top view of a seat for a valve shown in FIG. 1;

FIG. 7 is a side elevation view of a seat for a valve;

FIG. 8 is a top view of an insert for a valve;

FIG. 9 is a side elevation view of an insert for a valve;

FIG. 10 is a side elevation view of a corrugated rubber sleeve for the valve shown in FIG. 1.

### DETAILED DESCRIPTION

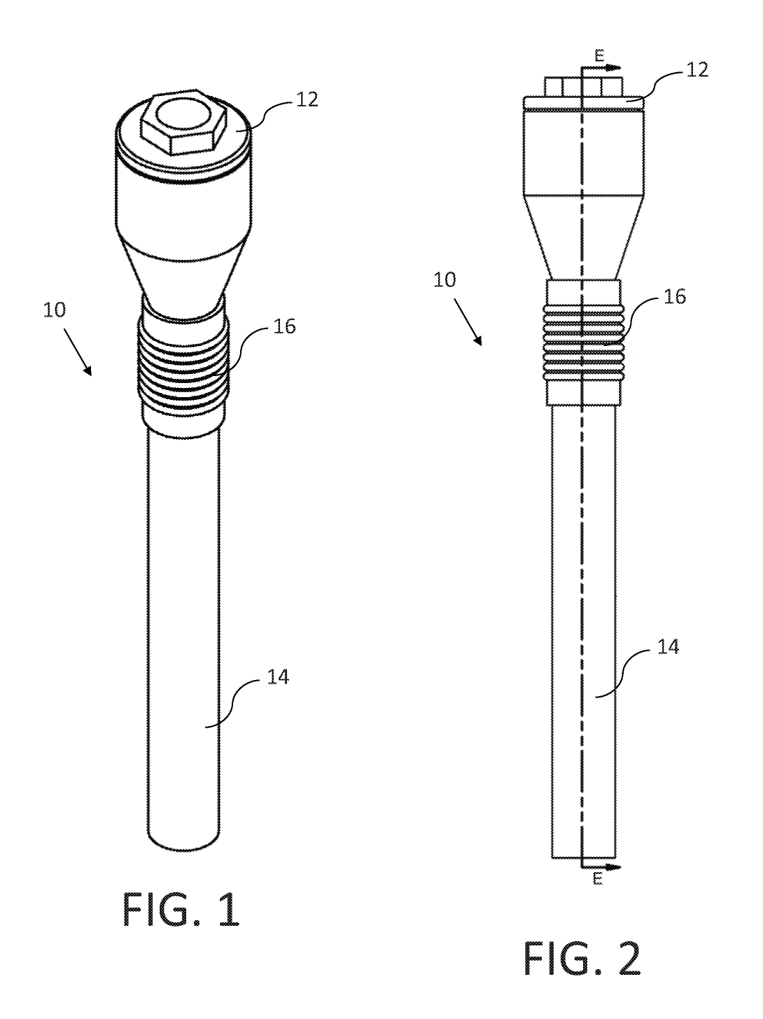

A hand controlled valve generally identified by reference numeral 10 will now be described with reference to FIGS. 1 through 10.

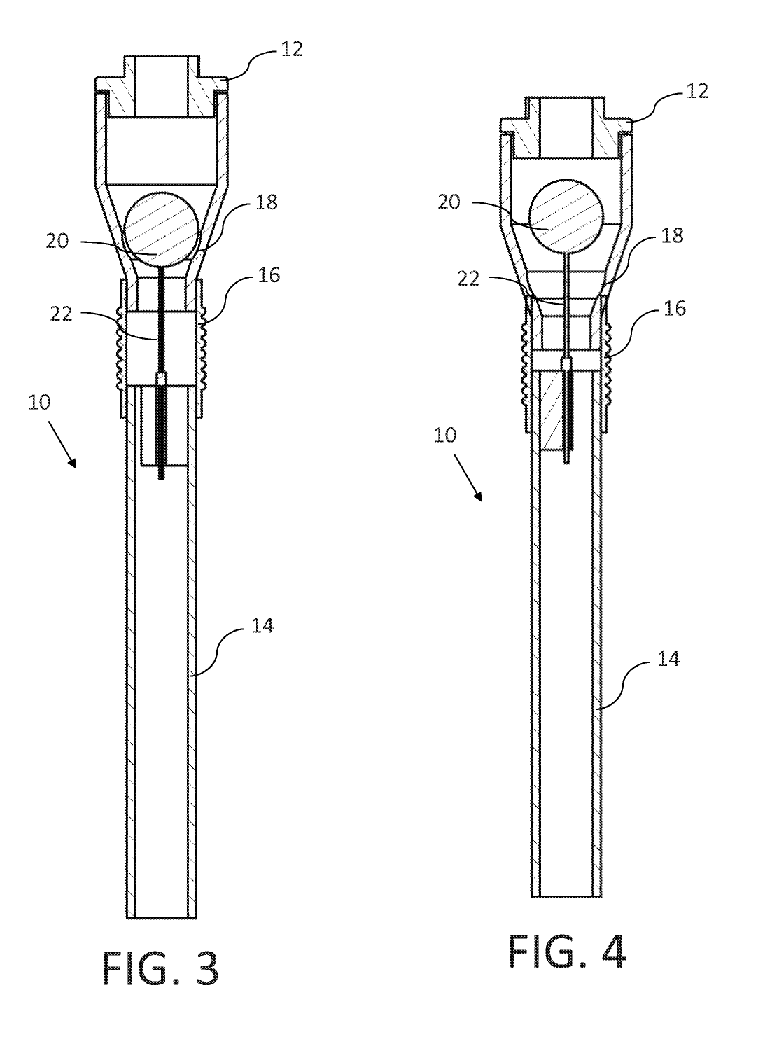

Referring to FIG. 1, valve 10 has an upper end 12 to be connected in fluid communication with a source of fluid, such as a fluid pipeline or fluid tank, and a fluid conduit 14 mounted by an adjustable connection 16. Upper end 12 and fluid conduit 14 may be formed from a variety of materials, as will be understood by those skilled in the art. For example, upper end 12 and fluid conduit 14 may be formed from steel, plastic, or aluminium. Valve 10 is designed to allow an operator to operate it using one hand and to be normally closed such that it closes when not in use. Referring to FIG. 3, valve 10 has a valve seat 18 below upper end 12 with a sealing member 20 positioned within valve 10 to selectively engage valve seat 18. As shown, sealing member 20 may be a ball, such as a ball formed of a resilient sealing material. Sealing member 20 may also take other forms, such a stopper having a ring seal around the exterior, or any form that allows sealing member 20 to form a seal against valve seat 18 and release when acted upon as described below. Sealing member 20 may be formed from a variety of materials, as will be understood by those skilled in the art, such as rubber, steel, or plastic. Referring to FIG. 6 and FIG. 7, valve seat 18 may be a shaped profile in a tapered conduit sized to receive sealing member 20 in such a way as to produce a seal. Valve seat 18 may also take other forms, depending on the type of sealing member 20 and the preferences of the user. For example, valve seat 18 may be formed from a variety of materials, such as rubber, steel, or plastic.

Referring to FIGS. 3 and 4, adjustable connection 16 permits the movement of fluid conduit 14 between a lower position seen in FIG. 3 and a raised position seen in FIG. 4. As depicted, adjustable connection 16 is a corrugated, flexible sleeve that contracts as the fluid conduit moves to the raised position, as shown in FIG. 10. As will be understood by those skilled in the art, adjustable connection 16 may take a variety of forms aside from a corrugated rubber sleeve, such as a cylinder with a V-shaped cross-section, a collapsible sleeve, or a sliding sleeve that has one or both ends that slides along an outer surface of valve 10, such as a lower end that allows fluid conduit 14 to slide upward, or an upper end that slides along upper end 12 of valve 10. This may require valve 10 to have a different shape, as will be understood by those skilled in the art. Adjustable connection 16 may also be a corrugated or moulded hose that is biased by gravity or spring loaded. In the case that adjustable connection 16 has a spring, and adjustable connection 16 is a corrugated or moulded hose, the spring may be moulded within the hose in order to protect the spring from damage, such as corrosion. Adjustable connection 16 may be made from a variety of materials depending on the application and the form of adjustable connection 16. For example, adjustable connection 16 may be formed from corrugated or moulded rubber, and the spring may be moulded within the rubber.

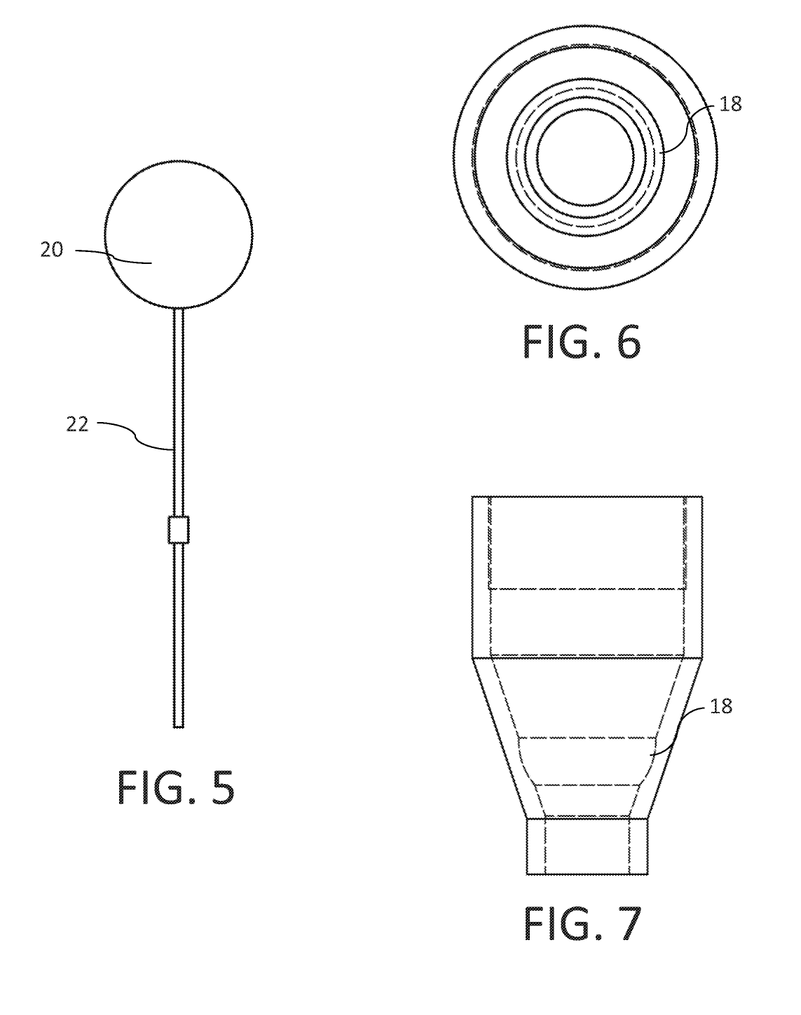

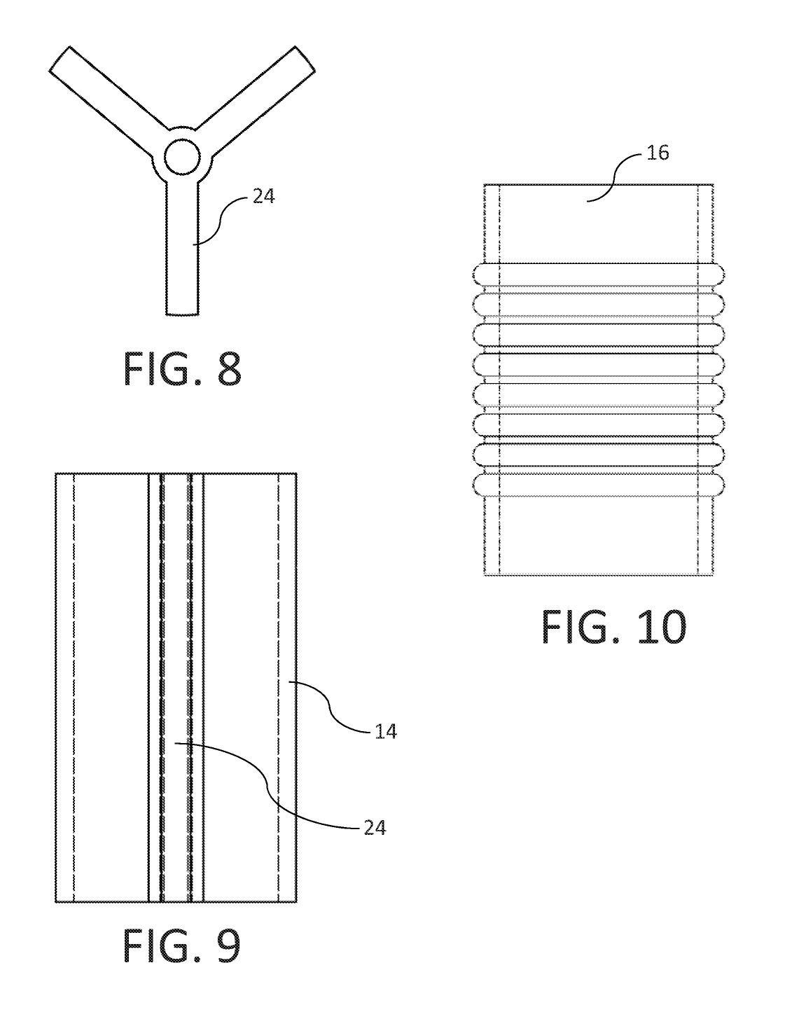

Referring again to FIG. 3 and FIG. 4, fluid conduit 14 carries an internal actuator 22 that displaces sealing member 20 upward from valve seat 18 when fluid conduit 14 is moved from the lower position to the raised position. Internal actuator 22 may take a variety of forms, such as one or more posts as shown in FIG. 3 and FIG. 4. Sealing member 20 is preferably fixedly attached to internal actuator 22, as shown in FIG. 5, such that it is carried upwards with internal actuator 22 out of engagement with valve seat 18 when fluid conduit 14 is moved from the lower position to the raised position. Alternatively sealing member 20 may not be attached to internal actuator 22 such that sealing member 20 is displaced by movement of internal actuator 22 from valve seat 18 without being carried by internal actuator 22. Referring to FIG. 8 and FIG. 9, fluid conduit 14 may also have an insert 24 that receives internal actuator 22 and attaches to fluid conduit 14, such that insert 24 is raised and lowered with fluid conduit 14. Insert 24 may, for example, be shaped to increase stability and control over internal actuator 22 without blocking fluid flow through fluid conduit 14. Sealing member 20 and internal actuator 22 may be biased to the closed position where sealing member 20 is seated on valve seat 18. This may be achieved by a variety of techniques as known in the art. For example, the weight of fluid conduit 14 may be used to bias sealing member 20 to as sealed position, as actuator 22 is carried by fluid conduit 14 and the force of gravity will act on fluid conduit 14 to pull it and internal actuator 22 downward. Adjustable connection 16 may be gravity or spring loaded in order to pull down on sealing member 20 to create a better seal. It will be understood by those skilled in the art that depending on the application, the force of gravity acting on fluid conduit 14 may be sufficient to form a seal, or it may be desired to further bias the sealing member 20 into a closed position by providing a spring within adjustable connection 16 that may apply additional downward pressure onto internal actuator 22 in order to form a more secure seal.

Referring to FIG. 3, when the source of fluid is filled with fluid, valve 10 is preferably in a normally closed position. Valve 10 may then be used, for example, to take a sample of fluid from the source of fluid. Fluid is caused to flow out of fluid conduit 14 by applying an upward force to fluid conduit 14, which moves fluid conduit 14 from a lower position to a raised position, as shown in FIG. 4. This causes internal actuator 22 to displace sealing member 20 from valve seat 18 as fluid conduit 14 moves upwards. Once sealing member 20 has been displaced from valve seat 18, the fluid passage between the source of fluid and fluid conduit 14 is open, and the fluid will flow out of fluid conduit 14 due to the effect of gravity. Once sufficient fluid has been obtained, the fluid flow out of fluid conduit 14 may be stopped by releasing the upward force on fluid conduit 14 and allowing gravity to return fluid conduit 14 to a lower position, which in turn allows internal actuator 22 to return to a lower position where it disengages and no longer displaces sealing member 20, allowing sealing member 20 to engage valve seat 18 to establish a seal and prevent continued flow of fluid out of fluid conduit 14.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A hand controlled valve that is normally closed and used for sampling fluid from a source of fluid, the valve comprising:
a valve body having an upper end connected to and in fluid communication with the source of fluid, the valve body having a valve seat below the upper end and a sealing member positioned within the valve body to selectively engage the seat; and
a fluid conduit mounted by an adjustable connection below the valve body, the adjustable connection permitting movement of the fluid conduit between a lower position and a raised position, the fluid conduit carrying an internal actuator, the internal actuator displacing the sealing member from the seat when the fluid conduit is moved from the lower position to the raised position.

2. The hand controlled valve of claim 1, wherein the source of fluid is a fluid pipe.

3. The hand controlled valve of claim 1, wherein the sealing member is a ball.

4. The hand controlled valve of claim 1, wherein the adjustable connection is a flexible sleeve that contracts as the fluid conduit moves to the raised position.

5. The hand controlled valve of claim 4, wherein the adjustable connection is a corrugated rubber sleeve.

6. The hand controlled valve of claim 1, wherein the sealing member is fixedly attached to the internal actuator.

7. The hand controlled valve of claim 6, wherein the weight of the fluid conduit biases the sealing member to a sealed position.

8. A method of using a normally closed, hand controlled valve with a source of fluid, the method comprising:
providing a valve comprising:
a valve body having an upper end connected to and in fluid communication with the source of fluid, the valve body having a valve seat below the upper end and a sealing member positioned within the valve body to selectively engage the seat; and
a fluid conduit mounted by an adjustable connection below the valve body, the adjustable connection permitting movement of the fluid conduit, the fluid conduit carrying an internal actuator;
causing fluid to flow out of the fluid conduit by applying an upward force to the fluid conduit to move the fluid conduit from a lower position to a raised position, the internal actuator displacing the sealing member from the seat as the fluid conduit moves upwards; and
stopping fluid flow out of the fluid conduit by releasing the fluid conduit and allowing gravity to return the fluid conduit to the lower position, the internal actuator disengaging from the sealing member and the sealing member engaging the seat to establish a seal.

9. The method of claim 8, wherein the source of fluid is a fluid pipe.

10. The method of claim 8, wherein the sealing member is a ball.

11. The method of claim 8, wherein the adjustable connection is a flexible sleeve that contracts as the fluid conduit moves to the raised position.

12. The method of claim 8, wherein the adjustable connection is a corrugated rubber sleeve.

13. The method of claim 8, wherein the sealing member is fixedly attached to the internal actuator.

14. The method of claim 8, wherein the weight of the fluid conduit biases the sealing member to a sealed position.
